(19) United States
(12) Patent Application Publication
(10) Pub. No.: US 2019/0260084 A1
(43) Pub. Date: Aug. 22, 2019

(54) RECHARGEABLE ELECTROCHEMICAL LITHIUM ION CELL

(71) Applicants: Filippos Farmakis, Xanthi (GR); Konstantinos Elmasidis, Xanthi (GR); Nikolaos Georgoulas, Christoupoli Kavala (GR); Democritus University of Thrace, Xanthi (GR); Centre For Research And Technology-Hellas (CERTH), Thermi, Thessaloniki (GR); European Space Agency, Paris (FR)

(72) Inventors: Filippos Farmakis, Xanthi (GR); Konstantinos Elmasidis, Xanthi (GR); Nikolaos Georgoulas, Christoupoli Kavala (GR); Dimitrios Tsiplakidis, Thessaloniki (GR); Styliani Balomenou, Thessaloniki (GR); Maria Nestoridi, AG Noordwijk (NL)

(21) Appl. No.: 16/315,483

(22) PCT Filed: Jun. 6, 2017
(86) PCT No.: PCT/GR2017/000030

§ 371 Date: Jan. 4, 2019

(30) Foreign Application Priority Data
Jul. 5, 2016 (GR) 20160100371

(51) Int. Cl. H01M 10/0569; H01M 4/58; H01M 10/0525; H01M 4/38; H01M 4/505; H01M 4/525; H01M 10/0568; H01M 10/0567; H01M 10/42

(52) U.S. Cl. CPC H01M 10/0569; H01M 4/5825; H01M 10/0525; H01M 4/386; H01M 2004/021; H01M 4/525; H01M 10/0568; H01M 10/0567; H01M 10/4235; H01M 4/505

(57) ABSTRACT

A rechargeable electrochemical lithium-ion cell for energy storage combines active materials (anode, cathode, electrolyte) in a way that it can operate with high energy density (>200 Wh/kg) and high performance during charging and discharging at a wide temperature range and more specifically at temperatures lower than −20° C. and at least as low as −40° C. The present disclosure facilitates the development of systems and devices requiring high energy density storage systems and thus low weight and operation at low temperature conditions with low energy consumption. The present disclosure can be applied to space technology, military applications as well as in the automotive industry where interest is focused on low weight batteries being capable to operate efficiently at low temperatures.

### BACKGROUND

### Technical Field

The present disclosure belongs to the field of electrochemical energy storage and more precisely to rechargeable lithium-ion batteries.

### Description of the Related Art

It is generally believed that the poor performance of lithium ion rechargeable cells at low temperatures are associated with: poor electrolyte conductivity, sluggish kinetics of charge transfer, increased resistance of solid electrolyte interphase, and slow lithium ion diffusion through the surface atomic layers and through the bulk of electrodes' active material particles. In order to solve this issue, two solutions have been proposed in the current state of the art: (i) to modify interfacial properties to reduce the high activation energy of charge-transfer kinetics, by surface coating or changing electrolyte composition and (ii) to increase interfacial area by using nanostructured electrodes or electrodes of different morphology. Additionally, major attention is given in the operating temperature range of the electrolyte, since lithium ion conductivity in the electrolyte seems to be the rate determining step at temperatures below 0° C. Therefore, little information can be found in the literature regarding the behavior of electrodes, anode or cathode, at these conditions.

The reduced performance problem at low temperatures is attempted to be solved by U.S. Pat. No. 6,399,255 B2, which describes a rechargeable lithium ion electrochemical cell comprising an electrolyte containing a lithium salt dissolved in a non-aqueous solvent, at least one positive electrode, and at least one negative electrode containing a carbon compound suitable for inserting lithium ions in its bulk and a binder made of a polymer that does not contain fluorine. The solvent of the electrolyte contains at least one saturated cyclic carbonate and at least one linear ester of a saturated aliphatic monocarboxylic acid. The cells with electrolytes containing ethyl acetate (EA) or methyl butyrate (MB) gave better results at −20° C., than cells that did not contain any EA or MB. At −40° C. the cells still gave three fourths of their initial ambient temperature capacity. Even though the cells were discharged at low temperature, they were always charged at room temperature which limited the opportunities of exploitation of such cells.

The reduced performance problem at low temperatures is also attempted to be solved by U.S. Pat. No. 7,722,985 B2 which describes a mixture of solvents for use as an electrolyte of a lithium ion battery. The mixture of solvents comprises 50 to 95% by volume of a linear ester of a C2 to C8 saturated acid and 5 to 50% by volume of a saturated cyclic carbonate (C3 to C6) and a saturated linear carbonate, only one of the two carbonates being substituted by at least one halogen atom. The battery according to this disclosure is able to operate at low temperatures down to −60° C.; however, only for discharging as charging should still be performed at high temperature (−25° C.)

The same problem of reduced performance at low temperatures is attempted to be solved by U.S. Pat. No. 8,920,981 B2 and US 2009/0253046 A1 which describe an electrolyte for use in lithium ion electrochemical cells that also operate at low temperatures. The electrolyte comprises a mixture of an ethylene carbonate (EC), an ethyl methyl carbonate (EMC), an ester, and a lithium salt. The ester comprises methyl propionate (MP), ethyl propionate (EP), methyl butyrate (MB), ethyl butyrate (EB), propyl butyrate (PB), or butyl butyrate (BB). An electrochemical cell, comprising an anode, a cathode, and the aforementioned electrolyte with a lithium salt, operates as far as delivery of stored energy (discharging) is concerned in a temperature range from −60° C. to 60° C. with the condition that the charging is performed at room temperature.

There has also been proposed (Electrochimica Acta 136 (2014) 182) the use of three kinds of polydimethylsiloxane (PDMS)-based copolymersas additives to standard liquid electrolyte solutions to enhance the lithium-ion battery performance at low temperatures. Liquid electrolyte solutions with PDMS-based copolymers are electrochemically stable up to 5.0 V and have adequate ionic conductivities at −20° C. As a result, the addition of PDMS-based additives to liquid electrolytes leads to capacity retention and operation at high discharging rate of lithium-ion batteries at low temperatures (e.g., 79% at −20° C.). Again, in this case, the cell is only discharged at low temperatures and the charging takes place at 25° C.

There has also been proposed (Int. J. Electrochem. Sci., 8 (2013) 8502) an electrolyte composition modification in cells consisting primarily of LiFePO₄ as active material in the cathode in order to improve cell performance at low temperatures. The enhancement of electrolyte conductivity was realized through optimizing the proportion of electrolyte's solvents. Solid electrolyte interphase modification was achieved by adding Li₂CO₃ in the high conductivity electrolyte of LiPF₆-EC/PC/EMC (0.14/0.18/0.68). For LiFePO₄ cathodic electrode cells, only 51.5% of its room temperature capacity was delivered at −30° C. with the addition of 4% Li₂CO₃ in the electrolyte. Moreover, in these cells the charging-discharging cycles were not performed entirely in the desired operating temperature (−30° C.) since charging was done at room temperature.

Following a theoretical and experimental study, it was reported (Journal of The Electrochemical Society, 160 (2013) A636) that the performance of a lithium ion battery at low temperatures and specifically at −20° C. in low charging rates depends on charge transfer kinetics which is the limiting factor in its operation. Optimization of cell design parameters and material properties resulted in a capacity value of 1.55 Ah at −20° C., compared to 2.2 Ah at room temperature. In this document there is no reference to cell results at temperatures lower than −40° C. Once again, cell charging takes place at room temperature.

In another publication (Journal of The Electrochemical Society, 157 (2010) A1361) an improved discharge performance and rate capability at low temperatures (down to −60° C.) for lithium-ion cells with ester and carbonate-based blended electrolytes is demonstrated. More specifically, improved performance was obtained with the use of electrolytes with the following composition: 1.0 M LiPF₆ in EC+EMC+X (20:60:20 v/v %) [where X=methyl propionate MP, ethyl propionate EP, methyl butyrate MB, ethyl butyrate EB, propyl butyrate PB, and butyl butyrate BB]. As also shown, a prototype cell containing the 1.0 M LiPF₆ EC+EMC+MP (20:60:20 v/v %) electrolyte was capable of delivering over six times the amount of capacity delivered by the baseline all-carbonate blend (without ester). Furthermore, the cell was able to support moderate rates at low temperatures (−50° C. and −60° C.). The discharge capacity at −40° C. was 77% of its value at room temperature. Even if this result is considered satisfactory, it has to be mentioned that cell charging is conducted at room temperature.

A common characteristic of all the above-mentioned disclosures is that the cell is discharged at low temperature conditions, though the cell is always charged at room temperature. This specific condition during charging is the main drawback of the proposed solutions since it necessitates the cell heat-up at room temperature (commonly with the aid of resistors) and thus the consumption of a large amount of energy during cell charging. This energy consumption during charging restricts the use of lithium-ion cells especially at applications where the available charging energy is limited while at the same time increases the total system cost.

### BRIEF SUMMARY

In brief, the present disclosure describes an electrochemical energy storage lithium-ion cell that combines active materials (anode, cathode, electrolyte) so that it can operate with high energy density (>200 Wh/kg) and high performance during charging and discharging at a wide temperature range and more specifically at temperatures lower than −20° C. and at least as low as −40° C., in contrast to existing technology, which cannot charge below −20° C.

The advantages presented by the present disclosure in comparison with the state-of-the-art technologies is the high cell energy density (>200 Wh/kg) along with the capability of the cells to be efficiently charged at low temperatures (at least −40° C.) delivering capacity more than 70% than the capacity provided at room temperature.

### BRIEF DESCRIPTION OF THE SEVERAL VIEWS OF THE DRAWINGS

In brief, the drawings illustrate the following:

FIG. 1 illustrates the basic arrangement of an electrochemical lithium ion cell as described herein.

FIG. 2 illustrates a graph presenting the conductivity of various electrolytes listed in Table 1 at room temperature, −10° C. and −40° C.

FIG. 3 illustrates a graph presenting the specific energy performance of the cell when the temperature is reduced consecutively from room temperature (RT) to −20° C. and to −40° C.

FIG. 4 illustrates a graph showing the cell voltage as a function of time during the battery charging and discharging at different temperatures.

### DETAILED DESCRIPTION

An application example of the present disclosure is presented with detailed description and references to the attached drawings.

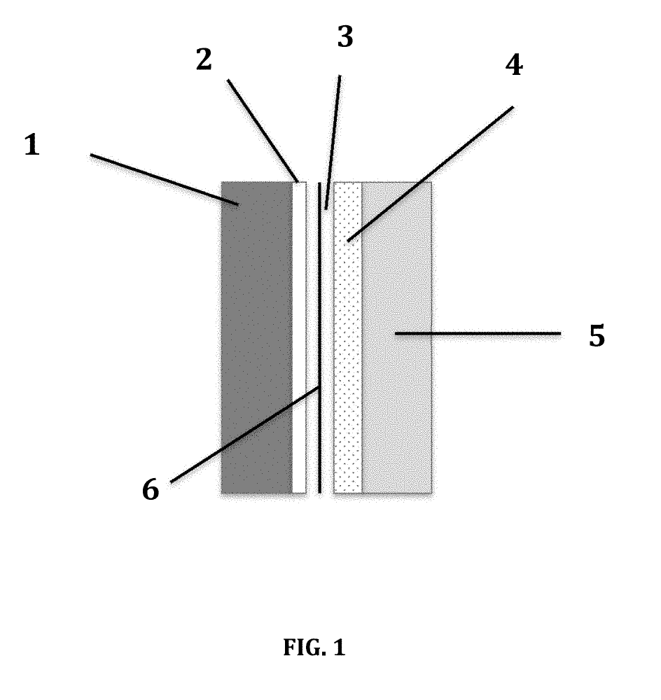

As shown in FIG. 1, an electrochemical lithium ion cell is comprised of the following elements:

At least one thin metal foil (1) that serves as current collector for the anode. The thin metal foil (1) can be made either from copper or other metal.

Microcrystalline or amorphous silicon film (2) formed in granular and/or columnar structure which has been deposited at least on one of the two sides of the thin metal foil (1) by techniques such as Physical Vapor Deposition (PVD), Chemical Vapor Deposition (CVD), spin coating, spray pyrolysis or others similar techniques. The anode material (2) should provide a high active surface with high specific capacity in lithium, higher than 1500 mAh/g.

Electrolyte (3) consisting of lithium hexafluorophosphate (LiPF₆) in a non-aqueous organic solvent. The non-aqueous organic solvent is composed of three parts:

(I) a ternary and/or quaternary mixture of linear and cyclic carbonates (ethylene carbonate, EC, dimethyl carbonate, DMC, diethyl carbonate, DEC, ethyl-methyl-carbonate, EMC, fluoroethylene carbonate, FEC) solvents,

(II) a low freezing point ester co-solvent agent (ethyl acetate, EA, or methyl butyrate, MB), and

(III) vinylene carbonate, VC, additive acting as a Solid Electrolyte Interphase (SEI) former. Fluoroethylene carbonate, FEC, might also be used as an additive.

Cathode (4) manufactured from material which is chosen between either spinel structured metal oxides having the general formula Li₁₋ₓ(M¹_{y}M²_{z}M³_{1-y-z})O₂ ((0≤x<1, 0≤y,z<1) where M¹, M² and M³ can be a combination of elements Ni, Co, Al, Fe and Mn or metal oxides, or olivine phosphates of the general formula LiMPO₄ where M is at least one of Co, Ni, Fe, and Mn. The best performance is obtained with a cathode having the general formula Li₁₋ₓ(Ni_{y}Co_{z}Al_{1-y-z})O₂.

At least one thin metal foil (5) that serves as current collector for the cathode on which the cathode's active material (4) has been deposited at least on one of the two sides. The thin metal foil (5) can be made of aluminum or other metal.

At least one separator (6) composed of polypropylene situated between the anodic (2) and the cathodic (4) electrode so that there is no electrical contact between the two electrodes. Separator (6) is drenched by the electrolyte (3).

The rechargeable lithium ion battery that is described above delivers, in terms of energy density, more than 200 Wh/kg. The electrolyte (3) that has been developed presents high ionic conductivity (>3 mS/cm) at low temperatures, such as −40° C. Table 1 presents a series of different electrolytes based on 1 M lithium hexafluorophosphate (LiPF₆) salt in non-aqueous solvents composed of (I) a ternary or quaternary mixture of linear and cyclic carbonates (ethylene carbonate, EC, dimethyl carbonate, DMC, diethyl carbonate, DEC, ethyl methyl carbonate, EMC) solvents, (II) a low freezing ester co-solvent agent (ethyl acetate, EA, or methyl butyrate, MB) and (III) vinylene carbonate, VC, as additive assisting the growth of stable Solid Electrolyte Interphase (SEI).

TABLE 1

| No. | EC | DMC | DEC | EMC | MB | EA | VC |
|---|---|---|---|---|---|---|---|
| 1 | 1 | 1 | 0 | 0 | 30% | 0 | 10% |
| 2 | 1 | 1 | 0 | 0 | 60% | 0 | 10% |
| 3 | 1 | 1 | 0 | 0 | 0 | 30% | 10% |
| 4 | 1 | 1 | 0 | 0 | 0 | 60% | 10% |
| 5 | 1 | 0 | 1 | 0 | 30% | 0 | 10% |
| 6 | 1 | 0 | 1 | 0 | 60% | 0 | 10% |
| 7 | 1 | 0 | 1 | 0 | 0 | 30% | 10% |
| 8 | 1 | 0 | 1 | 0 | 0 | 60% | 10% |
| 9 | 1 | 0 | 0 | 1 | 30% | 0 | 10% |
| 10 | 1 | 0 | 0 | 1 | 60% | 0 | 10% |
| 11 | 1 | 0 | 0 | 1 | 0 | 30% | 10% |
| 12 | 1 | 0 | 0 | 1 | 0 | 60% | 10% |
| 13 | 1 | 1 | 3 | 0 | 30% | 0 | 10% |
| 14 | 1 | 1 | 3 | 0 | 60% | 0 | 10% |
| 15 | 1 | 1 | 3 | 0 | 0 | 30% | 10% |
| 16 | 1 | 1 | 3 | 0 | 0 | 60% | 10% |
| 17 | 1 | 1 | 0 | 3 | 30% | 0 | 10% |
| 18 | 1 | 1 | 0 | 3 | 60% | 0 | 10% |
| 19 | 1 | 1 | 0 | 3 | 0 | 30% | 10% |
| 20 | 1 | 1 | 0 | 3 | 0 | 60% | 10% |
| 21 | 1 | 0 | 1 | 3 | 30% | 0 | 10% |
| 22 | 1 | 0 | 1 | 3 | 60% | 0 | 10% |
| 23 | 1 | 0 | 1 | 3 | 0 | 30% | 10% |
| 24 | 1 | 0 | 1 | 3 | 0 | 60% | 10% |
| 25 | 1 | 0 | 3 | 1 | 30% | 0 | 10% |
| 26 | 1 | 0 | 3 | 1 | 60% | 0 | 10% |
| 27 | 1 | 0 | 3 | 1 | 0 | 30% | 10% |
| 28 | 1 | 0 | 3 | 1 | 0 | 60% | 10% |
| 29 | 1 | 3 | 1 | 0 | 30% | 0 | 10% |
| 30 | 1 | 3 | 1 | 0 | 60% | 0 | 10% |
| 31 | 1 | 3 | 1 | 0 | 0 | 30% | 10% |
| 32 | 1 | 3 | 1 | 0 | 0 | 60% | 10% |
| 33 | 1 | 3 | 0 | 1 | 30% | 0 | 10% |
| 34 | 1 | 3 | 0 | 1 | 60% | 0 | 10% |
| 35 | 1 | 3 | 0 | 1 | 0 | 30% | 10% |
| 36 | 1 | 3 | 0 | 1 | 0 | 60% | 10% |

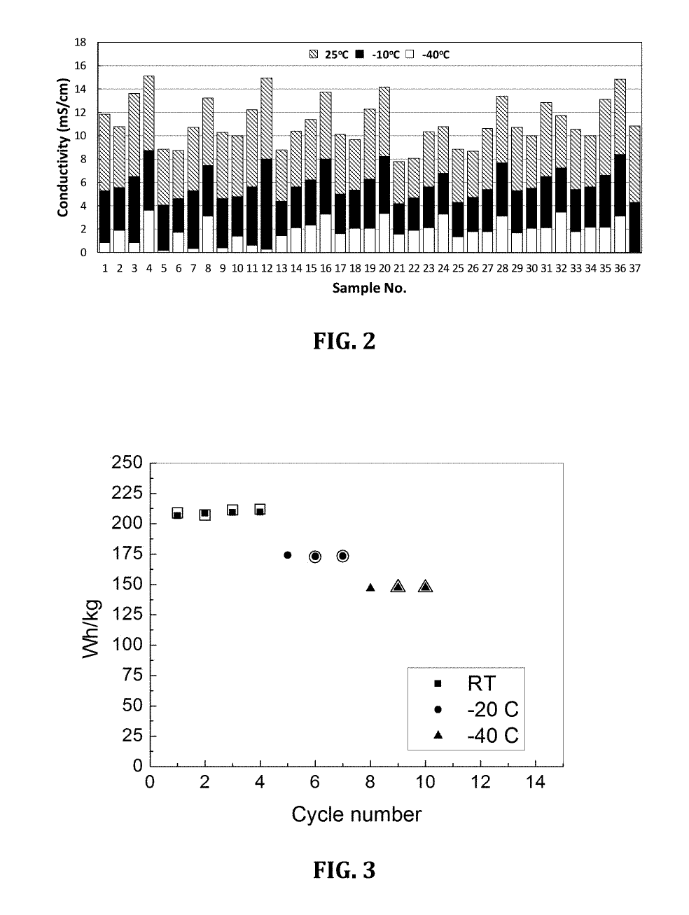

In FIG. 2, the conductivity results of the aforementioned electrolytes at room temperature, −10° C., −40° C. are illustrated. Electrolytes based on EC solvent with the addition of at least one of DMC or DEC as well as ethyl acetate EA with a concentration at least >30% exhibit conductivity higher than 3 mS/cm at the temperature of −40° C.

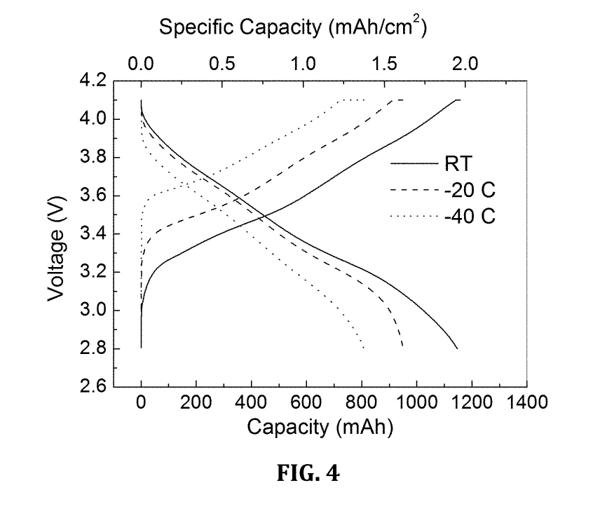

The anodic silicon substrate (2) combines a large active surface that facilitates the lithium diffusion into the bulk silicon with high specific capacity. The large surface area is due to the granular and/or columnar structure of the microcrystalline or amorphous silicon. The combination of the electrolyte (3) with the silicon surface anode (2) leads to excellent charge transfer rates at the interface electrolyte-anode electrode at subzero temperatures and thus allows the charging and discharging of the electrochemical system even at those low temperatures, mainly due to the low charge transfer impedance, in comparison with the electrochemical systems reported in the literature. It was experimentally demonstrated that the capacity retention of the electrochemical system in a charging/discharging cycle at −40° C. exceeds 70% and could potentially reach as high as 80% of the nominal capacity of the cell at room temperature (See FIG. 3 and FIG. 4).

The present disclosure is applied in the same manner if, in the electrolyte (3), something other than the salt lithium hexafluorophosphate (LiPF₆) is used such as lithium tetrafluoroborate (LiBF₄), lithium hexafluoroarsenate (LiAsF₆), or lithium perchlorate (LiClO₄).

The present disclosure is used in the fabrication of rechargeable lithium-ion batteries for their exploitation in applications requiring (i) high energy density storage systems and thus low weight and (ii) operation at low temperature conditions with low energy consumption during charging. In consequence, the present disclosure could potentially be put into practical use in space technology and military applications as well as in the automotive industry. Those application examples are representative and not exhaustive.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A rechargeable electrochemical lithium cell comprising at least one anode, at least one cathode, an electrolyte, and at least one separator, wherein:
the anode is made of a large active surface area material with high specific capacity larger than 1500 mAh/g; and
the electrolyte is composed of:
at least one ternary mixture of solvents,
at least one ester co-solvent with a low melting point,
at least one additive acting as a solid electrolyte interphase former, and
at least one lithium salt.

2. A rechargeable electrochemical lithium cell according to claim 1 wherein the at least one ternary mixture of solvents is composed of linear and cyclic carbonates between ethylene carbonate EC, dimethyl carbonate DMC, diethyl carbonate DEC, ethyl methyl carbonate EMC and fluoroethylene carbonate FEC.

3. A rechargeable electrochemical lithium cell according to claim 1 wherein the at least one ester co-solvent with a low melting point is ethyl acetate EA, butyl acetate MB, or a mixture thereof with concentration higher than 30% v/v.

4. A rechargeable electrochemical lithium cell according to claim 1 wherein the at least one additive acting as a solid electrolyte interphase former is vinyl acetate VC.

5. A rechargeable electrochemical lithium cell according to claim 1 wherein the at least one additive acting as a solid electrolyte interphase former is fluoroethylene carbonate FEC.

6. A rechargeable electrochemical lithium cell according to claim 1 wherein the at least one lithium salt comprises at least one of lithium hexafluorophosphate (LiPF₆), lithium tetrafluoroborate (LiBF₄), lithium hexafluoroarsenate (LiAsF₆), lithium perchlorate (LiClO₄).

7. A rechargeable electrochemical lithium cell according to claim 1 wherein the anode is made of amorphous or microcrystalline silicon film in granular structure and deposited at least on the one side of the thin metal foil.

8. A rechargeable electrochemical lithium cell according to claim 1 wherein the anode is made of amorphous or microcrystalline silicon film in columnar structure and deposited at least on the one side of the thin metal foil.

9. A rechargeable electrochemical lithium cell according to claim 1 wherein the cathode is made of a material having the general formula Li₁₋ₓ(M¹_{y}M²_{z}M³_{1-y-z})O₂ (0≤x<1, 0≤y,z<1) where M¹, M² and M³ can be, in combination, one of elements Ni, Co, Al, Fe and Mn and metal oxides.

10. A rechargeable electrochemical lithium cell according to claim 1 wherein the cathode is made of olivine phosphates of the general formula LiMPO₄ where M is at least one of Co, Ni, Fe, and Mn.
